(19) United States
(12) Patent Application Publication
(10) Pub. No.: US 2010/0022701 A1
(43) Pub. Date: Jan. 28, 2010

(54) FINELY DIVIDED, CATIONIC POLYMER DISPERSIONS

(75) Inventors: Andreas Brockmeyer, Alsbach-Haehnlein (DE); Titus Leman, Shanghai (CN); Roland Ettl, Altlussheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/519,001

(22) PCT Filed: Dec. 11, 2007
(86) PCT No.: PCT/EP2007/063684

§ 371 Date: Jun. 12, 2009

(30) Foreign Application Priority Data
Dec. 14, 2006 (EP) 06126099.8

(51) Int. Cl. C08L 33/08; C08L 33/10

(52) U.S. Cl. 524/533

(57) ABSTRACT

Finely divided, cationic polymer dispersions which are obtainable by emulsion polymerization of ethylenically unsaturated monomers in an aqueous solution of a cationic prepolymer as a dispersant, wherein a cationic prepolymer is first prepared by polymerization of
(a) from 10 to 45% by weight of at least one (meth)acrylate which has an amino group and/or a quaternary ammonium group, and/or one (meth)acrylamide which carries an amino group and/or a quaternary ammonium group,
(b) from 40 to 85% by weight of at least one optionally substituted styrene,
(c) from 0 to 20% by weight of acrylonitrile or methacrylonitrile,
(d) from 1 to 15% by weight of at least one ethylenically unsaturated carboxylic acid or one ethylenically unsaturated carboxylic anhydride and
(e) from 0 to 20% by weight of at least one nonionic, ethylenically unsaturated monomer differing from the monomers (b) and (c),
   the sum of (a)+(b)+(c)+(d)+(e) being 100% by weight, in a solution polymerization in a water-miscible organic solvent, and the solution of prepolymer thus prepared is diluted with water, and wherein an emulsion polymerization of a monomer mixture comprising
(i) from 30 to 80% by weight of acrylonitrile and/or methacrylonitrile,
(ii) from 5 to 50% by weight of at least one C₁- to C₄-alkyl acrylate or at least one C₁- to C₄-alkyl methacrylate,
(iii) from 5 to 50% by weight of at least one C₆- to C₁₄-alkyl acrylate or at least one C₆- to C₁₄-alkyl methacrylate and
(iv) from 0 to 20% by weight of a nonionic monomer differing from the monomers (i), (ii) and (iii),
   the sum (i)+(ii)+(iii)+(iv) being 100% by weight, is then carried out in the aqueous solution of the prepolymer in the presence of water-soluble polymerization initiators,
   and the use of the finely divided, cationic polymer dispersions thus obtainable as engine sizes and surface sizes for paper, board and cardboard.

The invention relates to finely divided, cationic polymer dispersions which are obtainable by emulsion polymerization of ethylenically unsaturated monomers in an aqueous solution of a cationic prepolymer as a dispersant.

DE-A 24 54 397 discloses a process for the preparation of cationic aqueous copolymer dispersions by emulsion polymerization of olefinically unsaturated monomers in the presence of cationic dispersants, an emulsion polymer of an acrylate, styrene and/or acrylonitrile and/or methyl methacrylate and, if appropriate, other monomers, which have a glass transition temperature of from −15 to +60° C., being prepared as a cationic dispersant in an aqueous solution or dispersion of a low molecular weight prepolymer of styrene and/or a (meth)acrylate and a monoolefinically unsaturated monomer which has tertiary, protonated tertiary or quaternary nitrogen atoms. The polymer dispersions thus obtainable are used as sizes for paper.

EP-A 051 144 discloses amphoteric, finely divided, aqueous polymer dispersions which are prepared by a two-stage polymerization. In the first stage of the preparation, a low molecular weight, amphoteric prepolymer which in each case comprises from 0.5 mol to 1.5 mol of an ethylenically unsaturated carboxylic acid incorporated in the form of polymerized units per mole of a nitrogen-containing monomer which carries an amino group and/or a quaternary amino group is synthesized in a solution copolymerization—the preferred solvent is glacial acetic acid. The prepolymer is then dispersed in water and reacted in an emulsion polymerization with nonionic, ethylenically unsaturated monomers using customary water-soluble initiators. The dispersions obtained are used as engine sizes and surface sizes for paper.

EP-B 257 412 discloses paper sizes based on finely divided, aqueous dispersions of copolymers which are obtainable by copolymerization of acrylonitrile and/or methacrylonitrile, an acrylate and, if appropriate, other ethylenically unsaturated copolymerizable monomers by an emulsion polymerization method in an aqueous solution of a degraded starch having a viscosity ηᵢ of from 0.12 to 0.5 dl/g using hydrogen peroxide or redox initiators. As is evident from the examples, the starch is enzymatically degraded. The enzymatic degradation of the starch is stopped by adding acetic acid.

Emulsion polymers having a corresponding composition are disclosed in EP-B 276 770. They differ from the sizes disclosed in EP-B 257 412 only in that they are prepared in an aqueous solution of a degraded starch having a viscosity ηᵢ of from 0.04 to less than 0.12 dl/g.

U.S. Pat. No. 4,659,431 describes a cationic paper size which is prepared in a two-stage process. A cationic solution copolymer is first prepared and is then used as an emulsifier in an emulsion polymerization. The solution copolymer is synthesized in an alcohol from a monomer mixture consisting of N,N-dimethylaminoethyl acrylate and/or methacrylate, styrene and acrylonitrile. Thereafter, at least 10% of the N,N-dimethylamino groups are quaternized. In the second stage, the emulsion polymerization of styrene, acrylates and/or methacrylates and, if appropriate, acrylonitrile is effected with the use of water-soluble initiators. In addition, cationic and/or nonionic emulsifiers are also added in some cases.

EP-A 1 180 527 discloses cationic, finely divided, aqueous polymer dispersions which are used as engine sizes and surface sizes for paper. The preparation of the dispersion is likewise effected in a two-stage process in which a cationic solution polymer is first synthesized and subsequently acts as an emulsifier in an emulsion polymerization. The emulsion polymerization is carried out using customary, water-soluble initiators, e.g. peroxides together with redox systems. No carboxylic acids capable of being incorporated in the form of polymerized units, such as acrylic acid or methacrylic acid, are used in the preparation of the solution polymer because this would lead to an increased tendency to frothing of the product in the surface sizing of paper.

It is the object of the invention to provide further aqueous polymer dispersions which can be used as paper sizes.

The object is achieved, according to the invention, by finely divided, cationic polymer dispersions which are obtainable by emulsion polymerization of ethylenically unsaturated monomers in an aqueous solution of a cationic prepolymer as a dispersant, if the cationic prepolymer is first prepared by polymerization of
(a) from 10 to 45% by weight of at least one (meth)acrylate which has an amino group and/or a quaternary ammonium group, and/or at least one (meth)acrylamide which carries an amino group and/or a quaternary ammonium group,
(b) from 40 to 85% by weight of at least one optionally substituted styrene,
(c) from 0 to 20% by weight of acrylonitrile or methacrylonitrile,
(d) from 1 to 15% by weight of at least one ethylenically unsaturated carboxylic acid or one ethylenically unsaturated carboxylic anhydride and
(e) from 0 to 20% by weight of at least one nonionic, ethylenically unsaturated monomer differing from the monomers (b) and (c),
   the sum of (a)+(b)+(c)+(d)+(e) being 100% by weight, in a solution polymerization in a water-miscible organic solvent, and the solution of prepolymer thus prepared is diluted with water, and if an emulsion polymerization of a monomer mixture comprising
(i) from 30 to 80% by weight of acrylonitrile and/or methacrylonitrile,
(ii) from 5 to 50% by weight of at least one C₁- to C₄-alkyl acrylate or at least one C₁- to C₄-alkyl methacrylate,
(iii) from 5 to 50% by weight of at least one C₆- to C₁₄-alkyl acrylate or at least one C₆- to C₁₄-alkyl methacrylate and
(iv) from 0 to 20% by weight of a nonionic monomer differing from the monomers (i), (ii) and (iii),
   the sum (i)+(ii)+(iii)+(iv) being 100% by weight, is then carried out in the aqueous solution of the prepolymer in the presence of water-soluble polymerization initiators. The amount of the cationic monomers (a) which are incorporated into the prepolymer is always higher than the amount of the anionic monomers (d), so that the prepolymer is cationic.

Finely divided, cationic polymer dispersions are preferred, wherein the cationic prepolymer is obtainable by polymerization of
(a) N,N-dimethylaminopropylmethacrylamide and/or N,N-dimethylaminoethyl methacrylate and/or N,N-dimethylaminoethyl acrylate,
(b) styrene
   and
(d) acrylic acid and/or methacrylic acid
   or by polymerization of
(a) N,N-dimethylaminopropylmethacrylamide and/or N,N-dimethylaminoethyl methacrylate and/or N,N-dimethylaminoethyl acrylate,
(b) styrene,
(c) acrylonitrile and
(d) acrylic acid and/or methacrylic acid.

The preferred finely divided, cationic polymer dispersions furthermore include polymer dispersions in which the emulsion polymer is obtainable by polymerization of a monomer mixture comprising
(i) acrylonitrile,
(ii) n-butyl acrylate, isobutyl acrylate and/or tert-butyl acrylate and
(iii) ethylhexyl acrylate.

Particularly preferred finely divided, cationic polymer dispersions are those in which the cationic prepolymer is obtainable by polymerization of
(a) N,N-dimethylaminopropylmethacrylamide and/or N,N-dimethylaminoethyl methacrylate and/or N,N-dimethylaminoethyl acrylate,
(b) styrene
   and
(d) acrylic acid
   and the emulsion polymer is obtainable by polymerization of a monomer mixture comprising
(i) acrylonitrile,
(ii) n-butyl acrylate and/or tert-butyl acrylate and
(iii) ethylhexyl acrylate.

The cationic prepolymer which acts as a dispersant for the emulsion polymerization is prepared in a first stage of the polymerization. It is a solution polymer which, if appropriate, can be stored for a relatively long time. It is preferably used as a dispersant immediately after its preparation in the second stage of the polymerization.

The cationic prepolymer is obtainable by polymerization of the abovementioned monomer mixtures (a), (b), if appropriate (c), (d) and if appropriate (e) in the presence of at least one polymerization initiator.

At least one (meth)acrylate which has an amino group and/or a quaternary ammonium group and/or at least one (meth)acrylamide which comprises an amino group and/or a quaternary ammonium group as substituents are used as monomers (a). These are monomers of the general formula I

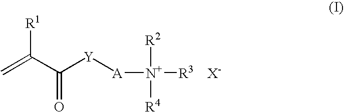

where

R¹ is hydrogen or C₁-C₄-alkyl, in particular hydrogen or methyl,

R² and R³, independently of one another, are C₁-C₄-alkyl, in particular methyl, and

R⁴ is hydrogen or C₁-C₄-alkyl, in particular hydrogen or methyl,

Y is oxygen, NH or NR⁵ where R⁵ is C₁-C₄-alkyl,

A is C₂-C₈-alkylene, e.g. 1,2-ethanediyl, 1,2- or 1,3-propanediyl, 1,4-butanediyl or 2-methyl-1,2-propanediyl, which, if appropriate, is interrupted by 1, 2 or 3 non-neighboring oxygen atoms, and

X— is an anion equivalent, e.g. Cl—, HSO₄—, ½ SO₄²— or CH₃OSO₃— etc.,

and for Y═H the free bases of the monomers of the formula I.

Examples of such monomers are 2-(N,N-dimethylamino)ethyl acrylate, 2-(N,N-dimethylamino)ethyl methacrylate, 2-(N,N-dimethylamino)ethylacrylamide, 3-(N,N-dimethylamino)propylacrylamide, 3-(N,N-dimethylamino)propylmethacrylamide, 2-(N,N-dimethylamino)ethylmethacrylamide, 2-(N,N,N-trimethylammonium)ethyl acrylate chloride, 2-(N,N,N-trimethylammonium)ethyl methacrylate chloride, 2-(N,N,N-trimethylammonium)ethylmethacrylamide chloride, 3-(N,N,N-trimethylammonium)propylacrylamide chloride, 3-(N,N,N-trimethylammonium)propylmethacrylamide chloride, 2-(N,N,N-trimethylammonium)ethylacrylamide chloride, and the corresponding methosulfates and sulfates.

The amino groups can, if appropriate, be present completely or partly as a salt (ammonium groups). The monomers (a) are present in an amount of from 10 to 45% by weight, preferably from 15 to 30% by weight, in the monomer mixture to be polymerized.

The monomer mixtures comprise, as monomer (b), at least one optionally substituted styrene, for example styrene, α-methylstyrene, ethylstyrene or vinyltoluene.

Styrene is preferably used as monomer (b). The monomers (b) are present in an amount of from 40 to 85% by weight, preferably from 55 to 75% by weight, in the monomer mixture.

In order to modify the prepolymer, the monomer mixtures may comprise, as component (c), from 0 to 20% by weight, preferably from 5 to 15% by weight, of acrylonitrile or methacrylonitrile.

The monomer mixture comprises, as monomer (d), at least one ethylenically unsaturated carboxylic acid or one ethylenically unsaturated carboxylic anhydride, such as maleic anhydride or itaconic anhydride. Suitable ethylenically unsaturated carboxylic acids are, for example, C₃- to C₆-mono- and dicarboxylic acids, e.g. acrylic acid, methacrylic acid, maleic acid, fumaric acid, vinylacetic acid, crotonic acid, itaconic acid, vinyllactic acid and monoesters of ethylenically unsaturated carboxylic acids, for example monomethyl maleate, monoethyl maleate or mono-tert-butyl maleate. Acrylic acid and methacrylic acid or mixtures of these acids are preferably used in the polymerization. The ethylenically unsaturated carboxylic acid can also be used in a form completely or partly neutralized with bases for the preparation of the prepolymers. Preferred neutralizing agents are sodium hydroxide solution, potassium hydroxide solution or ammonia. The amounts of monomers (d) used in the polymerization are from 1 to 15% by weight, preferably from 2 to 10% by weight, based on the monomer mixture. Since the amount of the cationic monomers (a) is greater than the amount of the anionic monomers (d), the resulting amphoteric prepolymers always have an overall cationic charge.

The monomer mixture which is used for the preparation of the prepolymer may comprise from 0 to 20% by weight, in general only up to 10% by weight, of at least one nonionic, ethylenically unsaturated monomer (e) differing from the monomers (b) and (c), for example acrylamide, methacrylamide, N-methylolacrylamide and N-methylolmethacrylamide, for modifying the polymer.

The monomers which are suitable for the preparation of the prepolymer are polymerized in a solution polymerization in a water-miscible organic solvent. Solvents used are, for example, formic acid, acetic acid, propionic acid, alcohols, such as methanol, ethanol, n-propanol, isopropanol, n-butanol, isobutanol, cyclohexanol, n-hexanol, ethylene glycol, propylene glycol, diethylene glycol, ketones, such as acetone or methyl ether ketone, tetrahydrofuran, dimethylformamide or mixtures of said solvents. The solvents may comprise up to 15% by weight of water. However, substantially anhydrous solvents are preferably used. The amount of solvent is generally chosen so that the polymer solutions which comprise from 20 to 75% by weight, preferably from 40 to 70% by weight, of prepolymer form.

The prepolymers have, for example, average molar masses M_{w} of up to 50 000, in general molar masses M_{w} in the range of from 500 to 20 000, preferably from 1000 to 15 000. In order to regulate the molar mass of the prepolymers, if appropriate at least one polymerization regulator, such as mercaptoethanol, thioglycolic acid, dodecyl mercaptan or tetrabromomethane, may be used in the polymerization. In addition, the molar mass of the polymers can be adjusted with the aid of the amount of polymerization initiator used.

The polymerization is carried out in the presence of at least one polymerization initiator. The polymerization temperature is, for example, in the range of from 40 to 150° C., preferably from 50 to 95° C. For example, azo initiators, peroxides, hydroperoxides, hydrogen peroxide or redox catalysts may be used as initiators. Tert-butyl perbenzoate, benzoyl peroxide, tert-butyl peroxide and tert-butyl peroctanoate are preferably used as initiators in the preparation of the prepolymer.

The solution of the cationic prepolymer is mixed with water. One part by weight of the solution of the prepolymer is mixed, for example, with from 1 to 50 parts by weight of water, preferably with from 1 to 20 parts by weight of water. If desired, the organic solvent which was used for the preparation of the prepolymer can be completely or partly removed from the polymer solution before or after the addition of water, expediently by distilling off under reduced pressure.

The preparation of the emulsion polymer is effected in the aqueous solution of the prepolymer, in a second polymerization stage. For this purpose, a monomer mixture comprising
(i) from 30 to 80% by weight of acrylonitrile and/or methacrylonitrile,
(ii) from 5 to 50% by weight of at least one C₁- to C₄-alkyl acrylate or at least one C₁- to C₄-alkyl methacrylate,
(iii) from 5 to 50% by weight of at least one C₆- to C₁₄-alkyl acrylate or at least one C₆- to C₁₄-alkyl methacrylate and
(iv) from 0 to 20% by weight of a nonionic monomer differing from the monomers (i), (ii) and (iii).
   is polymerized.

The monomer mixture preferably comprises
(i) from 40 to 70% by weight of acrylonitrile and/or methacrylonitrile,
(ii) from 10 to 40% by weight of at least one C₁- to C₄-alkyl (meth)acrylate,
(iii) from 5 to 20% by weight of at least one C₆- to C₁₄-alkyl (meth)acrylate and
(iv) up to 10% by weight of acrylamide and/or methacrylamide.

Monomers (ii) are, for example, methyl acrylate, ethyl acrylate, n-propyl acrylate, isopropyl acrylate, n-butyl acrylate, sec-butyl acrylate, isobutyl acrylate, tert-butyl acrylate, methyl methacrylate, ethyl methacrylate, n-propyl methacrylate, isopropyl methacrylate, n-butyl methacrylate, isobutyl methacrylate and sec-butyl methacrylate. Of this group of monomers, n-butyl acrylate and tert-butyl acrylate are preferably used.

Monomers of the group consisting of group (iii) are, for example, hexyl acrylate, cyclohexyl acrylate, n-octyl acrylate, 2-ethylhexyl acrylate, decyl acrylate, dodecyl acrylate, tetradecyl acrylate, hexyl methacrylate, cyclohexyl methacrylate, n-octyl methacrylate, 2-ethylhexyl methacrylate, dodecyl methacrylate and tetradecyl methacrylate. Of this group of monomers, ethylhexyl acrylate and ethylhexyl methacrylate are particularly suitable.

Suitable monomers of group (iv) are, for example, acrylamide, methacrylamide, N-methylolacrylamide, N-methylolmethacrylamide, N—C₁- to C₁₈-alkylacrylamides, N—C₁- to C₁₈-alkylmethacrylamides, N-vinylamides, C₁- to C₁₈-alkyl vinyl ethers, hydroxyalkyl esters and esters of monoethylenically unsaturated mono- and dicarboxylic acids with C₂-C₄-polyalkylene glycols.

The monomers of group (iv) furthermore include the monoethylenically unsaturated monomers which have already been mentioned under (a) and have at least one cationic group and/or at least one amino group protonatable in an aqueous medium, a quaternary ammonium group, a protonatable imino group or a quaternized imino group.

In addition, crosslinking monomers may also be used. Examples of such crosslinking agents are butanediol diacrylate, butanediol dimethacrylate, hexanediol diacrylate, hexanediol dimethacrylate, glycol diacrylate, glycol dimethacrylate, trimethylolpropane triacrylate, trimethylolpropane trimethyacrylate, pentaerythrityl triacrylate, pentaerythrityl tetraacrylate, diacrylates and dimethacrylates of alkoxylated dihydric alcohols, divinylurea and/or conjugated diolefins, such as butadiene or isoprene.

Depending on the intended use, the monomers of group (iv) may also comprise so-called functional monomers, i.e. monomers which, in addition to a polymerizable C═C double bond, also have a reactive functional group, for example an oxirane group, a reactive carbonyl group, e.g. an acetoacetyl group, an isocyanate group, an N-hydroxymethyl group, an N-alkoxymethyl group, a trialkylsilyl group, a trialkoxysilyl group or another group reactive toward nucleophiles.

The polymerization of the monomers (i), (ii), (iii) and if appropriate (iv) is effected by an emulsion polymerization method, i.e. the monomers to be polymerized are present as an aqueous emulsion in the polymerization mixture. The cationic prepolymers described above are used for stabilizing the monomer emulsions.

The monomers can be initially taken in the reactor before the beginning of the polymerization or added to the polymerizing reaction mixture or the aqueous mixture of the cationic prepolymer in one or more portions or continuously under polymerization conditions. For example, the main amount of the monomers, in particular at least 80% and particularly preferably the total amount, can be initially taken in the polymerization vessel together with the prepolymer and the polymerization started directly thereafter by adding a polymerization initiator. In a further process variant, a part (e.g. from 5 to 25%) of the monomers or of the monomer emulsion and a part of the prepolymer are first initially taken in the polymerization reactor, the polymerization is initiated by adding an initiator and the remaining amount of monomers or monomer emulsion and, if appropriate, prepolymer are added to the reactor continuously or in portions and the polymerization with the monomers is completed. In this process variant, the polymerization initiator can, for example, be partly or completely initially taken in the reactor or metered into the reactor separately from the remaining monomers.

The initiators suitable for the emulsion polymerization are in principle all polymerization initiators which are usually used and are suitable for an emulsion polymerization and which initiate a free radical polymerization of ethylenically unsaturated monomers. These include, for example, azo compounds, such as 2,2′-azobisisobutyronitrile, 2,2′-azobis(2-methylbutyronitrile), 2,2′-azobis[2-methyl-N-(-2-hydroxyethyl)propionamide], 1,1′-azobis(1-cyclohexanecarbonitrile), 2,2′-azobis(2,4-dimethylvaleronitrile), 2,2′-azobis(N,N′-dimethyleneisobutyramidine)dihydrochloride, and 2,2′-azobis(2-amidinopropane) dihydrochloride, organic or inorganic peroxides, such as diacetyl peroxide, di-tert-butyl peroxide, diamyl peroxide, dioctanoyl peroxide, didecanoyl peroxide, dilauroyl peroxide, dibenzoyl peroxide, bis(o-toluoyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumyl hydroperoxide, tert-butyl peroxy-2-ethylhexanoate and diisopropyl peroxydicarbamate, salts of peroxodisulfuric acid and redox initiator systems.

A redox initiator system, in particular a redox initiator system which comprises a salt of peroxodisulfuric acid, hydrogen peroxide or an organic peroxide, such as tert-butyl hydroperoxide, as the oxidizing agent is preferably used for the polymerization. The redox initiator systems preferably comprise a sulfur compound which in particular is selected from sodium hydrogen sulfite, sodium hydroxymethane sulfonate and the hydrogen sulfite adduct of acetone as the reducing agent. Further suitable reducing agents are phosphorus-containing compounds, such as phosphorous acid, hypophosphites and phosphonates, and hydrazine or hydrazine hydrate and ascorbic acid. Redox initiator systems may furthermore comprise small added amounts of redox metal salts, such as iron salts, vanadium salts, copper salts, chromium salts or manganese salts, such as, for example, the redox initiator system ascorbic acid/iron(II) sulfate/sodium peroxodisulfate. Particularly preferred redox initiator systems are acetone bisulfite adduct/organic hydroperoxide, such as tert-butyl hydroperoxide; sodium disulfite (Na₂S₂O₅)/organic hydroperoxide, such as tert-butyl hydroperoxide; sodium hydroxymethanesulfinate/organic hydroperoxide, such as tert-butyl hydroperoxide; and ascorbic acid/hydrogen peroxide.

The initiator is usually used in an amount of from 0.02 to 2% by weight and in particular from 0.05 to 1.5% by weight, based on the amount of the monomers. Of course, the optimum amount of an initiator depends on the initiator system used and can be determined in routine experiments by the person skilled in the art. The initiator can be initially taken partly or completely in the reaction vessel. In general, a part of the amount of initiator is initially taken together with a part of the monomer emulsion, and the remaining initiator is added continuously or batchwise together with the monomers but separately therefrom.

Pressure and temperature are of minor importance for carrying out the polymerization of the monomers. Of course, the temperature depends on the initiator system used. The optimum polymerization temperature can be determined by the person skilled in the art with the aid of routine experiments. Usually, the polymerization temperature is in the range of from 0 to 110° C., frequently in the range of from 30 to 95° C. The polymerization is usually carried out at atmospheric pressure or ambient pressure. However, it can also be carried out at superatmospheric pressure, e.g. up to 10 bar, or at reduced pressure, e.g. at from 20 to 900 mbar, but in general at >800 mbar. The duration of polymerization is, preferably, from 1 to 120 minutes, in particular from 2 to 90 minutes and particularly preferably from 3 to 60 minutes, longer or shorter durations of polymerization also being possible.

Polymerization is preferably effected under the so-called “starved conditions”, i.e. conditions which as far as possible permit only little or no formation of empty micelles. For this purpose, either no further surface-active substance is added or only so little further surface-active substance that the water-insoluble monomer droplets in the aqueous phase are stabilized.

If a dispersion stabilizer is additionally added in the emulsion polymerization for stabilizing the resulting emulsion polymers, preferably at least one surface-active substance is metered in an amount of, for example, up to 5% by weight, e.g. from 0.1 to 5% by weight, based on the monomers to be polymerized. Suitable surface-active substances in addition to the nonionic surface-active substances are in particular anionic emulsifiers, e.g. alkylsulfates, alkanesulfonates, alkylarylsulfonates, alkyl ether sulfates, alkylaryl ether sulfates, anionic starch, sulfosuccinates, such as sulfosuccinic monoesters and sulfosuccinic diesters, and alkyl ether phosphates, and furthermore cationic emulsifiers.

In order to modify the properties of the polymers, the emulsion polymerization can, if appropriate, be carried out in the presence of at least one polymerization regulator. Examples of polymerization regulators are organic compounds which comprise sulfur in bound form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea, aldehydes, such as formaldehyde, acetaldehyde and propionaldehyde, organic acids, such as formic acid, sodium formate or ammonium formate, alcohols, such as, in particular isopropanol, and phosphorus compounds, such as sodium hypophosphite. If a regulator is used in the polymerization, the amount used in each case is, for example, from 0.01 to 5, preferably from 0.1 to 1, % by weight, based on the monomers used in the polymerization. Polymerization regulator and crosslinking agent can be used together in the polymerization. This makes it possible, for example, to control the rhelogoy of the resulting polymer dispersions.

The polymerization is carried out as a rule at a pH of from 2 to 9, preferably in the weakly acidic range at a pH of from 3 to 5.5. The pH can be adjusted to the desired value before or during the polymerization with customary acids, such as hydrochloric acid, sulfuric acid or acetic acid, or with bases, such as sodium hydroxide solution, potassium hydroxide solution, ammonia, ammonium carbonate, etc. The dispersion is preferably adjusted to a pH of from 5 to 7 with sodium hydroxide solution, potassium hydroxide solution or ammonia after the end of the polymerization.

In order to remove the remaining monomers as substantially as possible from the polymer dispersion, a postpolymerization is expediently carried out after the end of the actual polymerization. For this purpose, for example, an initiator from the group consisting of hydrogen peroxide, peroxides, hydroperoxides and/or azo initiators is added to the polymer dispersion after the end of the main polymerization. The combination of the initiators with suitable reducing agents, such as, for example, ascorbic acid or sodium bisulfite, is also possible. Oil-soluble initiators sparingly soluble in water are preferably used, for example customary organic peroxides, such as dibenzoyl peroxide, di-tert-butyl peroxide, tert-butyl hydroperoxide, cumyl-hydroperoxide or biscyclohexyl peroxydicarbonate. For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. Tert-butyl hydroperoxide is preferably used for the postpolymerization. The polymerization is carried out, for example, in a temperature range of from 40 to 100° C., in general from 50 to 95° C.

The polymer dispersions comprise dispersed particles having a mean particle size of, for example, from 20 to 500 nm, preferably from 40 to 150 nm. The mean particle size can be determined by methods known to the person skilled in the art, such as, for example, laser correlation spectroscopy, ultracentrifuging, CHDF (capillary hydrodynamic fractionation). A further measure of the particle size of the dispersed polymer particles is the LT value (value for the light transmittance). For determining the LT value the polymer dispersion to be investigated in each case is measured in a 0.1% strength by weight aqueous dilution in a cell having an edge length of 2.5 cm using light of 600 nm wavelength and compared with the corresponding transmittance of water under the same measuring conditions. The transmittance of water is stated as 100%. The more finely divided the dispersion, the higher is the LT value which is measured by the method described above. The mean particle size can be calculated from the measured values, cf. for example Verner, M. Bárta, B. Sedlácek, Tables of Scattering Functions for Spherical Particles, Prague, 1976, Edice Marco, Rada D-DATA, SVAZEK D-1.

The solids content of the polymer dispersion is, for example, from 5 to 50% by weight and is preferably in the range of from 15 to 40% by weight.

The cationic polymer dispersions are used as engine sizes and surface sizes for paper, board and cardboard. The use as surface sizes is preferred. The polymer dispersions according to the invention can be processed by all methods suitable in surface sizing. For the application, the dispersion is usually added to the size press liquor in an amount of from 0.05 to 5% by weight, based on solid substance. The amount of polymer dispersion depends on the desired degree of sizing of the papers or paper products to be finished. The size press liquor may comprise further substances, such as, for example, starch, pigments, optical brighteners, biocides, strength agents for paper, fixing agents, antifoams, retention aids and/or drainage aids. The size dispersion can be applied to paper, board or cardboard by means of a size press or other application units, such as film press, speedsizer or gate-roll. The amount of polymer which is applied in this way to the surface of paper products is, for example, from 0.005 to 1.0 g/m², preferably from 0.01 to 0.5 g/m².

The polymer dispersions according to the invention can be used for the production of all paper varieties, for example of writing and printing papers and packaging papers, in particular of papers for the packaging of liquids.

Even when metered in very small amounts, the polymer dispersions according to the invention have an excellent sizing effect on all papers produced using different fiber types of unbleached softwood, unbleached deciduous wood, unbleached hardwood, bleached softwood, bleached deciduous wood, bleached hardwood, deinking fibers or mixtures of different fiber types. Furthermore, the dispersions according to the invention have very good compatibility with the customary starches, for example potato starch, cornstarch, wheat starch and tapioca starch. In addition, the dispersions according to the invention show complete size development immediately after the production and drying of the paper web.

Unless otherwise evident from the context, the stated percentages in the examples are always percent by weight. The particle sizes were determined by means of a high performance particle sizer (HPPS) from Malvern using an He—Ne laser (633 nm) at a scattering angle of 173°.

### EXAMPLE 1

101.4 g of glacial acetic acid were initially taken in a 2 l flask having a plane-ground joint and a stirrer and internal temperature measurement and were heated to 105° C. under a nitrogen atmosphere. A mixture of 133.0 g of styrene, 57.0 g of N,N-dimethylaminopropylmethacrylamide and 5.0 g of methacrylic acid was metered in uniformly with stirring over a period of 45 min. The feed of 8.8 g of tert-butyl peroctanoate in 18.3 g of isopropanol was started simultaneously with the monomer feed and was metered into the reaction mixture in the course of 60 min. After the end of the initiator feed, stirring was continued for a further 30 min at a temperature of 105° C.

955 g of demineralized water were then added to the homogeneous mass of the prepolymer at 85° C. in the course of 30 min. After addition of 1.5 g of 10% strength iron(II) sulfate solution, 20 g of a 5% strength hydrogen peroxide solution were metered in in the course of 30 min. Thereafter, a mixture of 152.5 g of acrylonitrile, 30.5 g of ethylhexyl acrylate and 122.5 g of n-butyl acrylate was metered in uniformly at 75° C. over a period of 120 min. Simultaneously with the monomer feed, a separate feed of 80.0 g of a 5% strength hydrogen peroxide solution was metered in over a period of 150 min. After the end of the addition, stirring was continued for a further 60 min at 85° C. and the reaction mixture was then cooled to 50° C. For a reactivation, 5 g of an adduct of sodium sulfite with formaldehyde (Rongalit® C) were added and stirring was carried out again for 30 min at 70° C.

A finely divided polymer dispersion having a solids content of 30.1% and a mean particle size (Malvern) of 86 nm was obtained.

### EXAMPLE 2

116.4 g of glacial acetic acid were initially taken in a 2 l flask having a plane-ground joint and a stirrer and internal temperature measurement and were heated to 105° C. under a nitrogen atmosphere. A mixture of 161.55 g of styrene, 21.22 g of n-butyl acrylate, 64.84 g of N,N-dimethylaminopropylmethacrylamide and 5.89 g of acrylic acid was metered in uniformly with stirring over a period of 45 min. The feed of 8.8 g of tert-butyl peroctanoate in 18.3 g of isopropanol was started simultaneously with the monomer feed and was metered into the reaction mixture in the course of 60 min. After the end of the initiator feed, stirring was continued for a further 30 min at a temperature of 105° C.

1078 g of demineralized water were then added to the homogeneous mass of the prepolymer at 85° C. in the course of 30 min. After addition of 0.88 g of 10% strength iron(II) sulfate solution, 23.5 g of a 5% strength hydrogen peroxide solution were metered in in the course of 30 min. Thereafter, a mixture of 167.98 g of acrylonitrile, 33.6 g of ethylhexyl acrylate and 134.4 g of n-butyl acrylate was metered in uniformly at 85° C. over a period of 120 min. Simultaneously with the monomer feed, a separate feed of 94.3 g of a 5% strength hydrogen peroxide solution was metered in over 150 min. After the end of the addition, stirring was continued for a further 60 min at 85° C. and the reaction mixture was then cooled to 50° C. For reactivation, two portions of 2.65 g of an adduct of sodium sulfite with formaldehyde (Rongalit® C) were added and stirring was carried out again for 30 min at 70° C.

A finely divided polymer dispersion having a solids content of 37.12% and a mean particle size (Malvern) of 106 nm was obtained.

### EXAMPLE 3

101.4 g of glacial acetic acid were initially taken in a 2 l flask having a plane-ground joint and a stirrer and internal temperature measurement and were heated to 105° C. under a nitrogen atmosphere. A mixture of 133.0 g of styrene, 57.0 g of N,N-dimethylaminopropylmethacrylamide and 5.0 g of methacrylic acid was metered in uniformly with stirring over a period of 45 min. The feed of 8.8 g of tert-butyl peroctanoate in 18.3 g of isopropanol was started simultaneously with the monomer feed and was metered into the reaction mixture in the course of 60 min. After the end of the initiator feed, stirring was continued for a further 30 min at a temperature of 105° C.

955 g of demineralized water were then added to the homogeneous mass of the prepolymer at 85° C. in the course of 30 min. After addition of 1.5 g of 10% strength iron(II) sulfate solution, 20 g of a 5% strength hydrogen peroxide solution were metered in in the course of 30 min. Thereafter, a mixture of 213.5 g of acrylonitrile, 45.7 g of ethylhexyl acrylate and 45.7 g of n-butyl acrylate was metered in uniformly at 75° C. over a period of 120 min. Simultaneously with the monomer feed, a separate feed of 80.0 g of a 5% strength hydrogen peroxide solution was metered in over a period of 150 min. After the end of the addition, stirring was continued for a further 60 min at 85° C. and the reaction mixture was then cooled to 50° C. For a reactivation, 5 g of an adduct of sodium sulfite with formaldehyde (Rongalit® C) were added and stirring was carried out again for 30 min at 70° C.

A finely divided polymer dispersion having a solids content of 27.8% and a mean particle size (Malvern) of 71 nm was obtained.

### EXAMPLE 4

101.4 g of glacial acetic acid were initially taken in a 2 l flask having a plane-ground joint and a stirrer and internal temperature measurement and were heated to 105° C. under a nitrogen atmosphere. A mixture of 153.5 g of styrene, 65.75 g of dimethylaminoethyl methacrylate and 5.75 g of acrylic acid was metered in uniformly with stirring over a period of 45 min. The feed of 8.8 g of tert-butyl peroctanoate in 18.13 g of isopropanol was started simultaneously with the monomer feed and was metered into the reaction mixture in the course of 60 min. After the end of the initiator feed, stirring was continued for a further 30 min at a temperature of 105° C.

955 g of demineralized water were then added to the homogeneous mass of the prepolymer at 85° C. in the course of 30 min. After addition of 1.5 g of a 10% strength iron(II) sulfate solution and 2.5 g of Rongalit® C (adduct of sodium hydrogen sulfite with formaldehyde), 20 g of a 5% strength hydrogen peroxide solution were metered in in the course of 30 min. Thereafter, a mixture of 137.5 g of acrylonitrile, 110.0 g of n-butyl acrylate and 27.5 g ethylhexyl acrylate was metered in uniformly at 75° C. over a period of 120 min. Simultaneously with the monomer feed, a separate feed of 80.0 g of a 5% strength hydrogen peroxide solution was metered in over 150 min. After the end of the addition, stirring was continued for a further 60 min at 75° C. and the reaction mixture was then cooled to 50° C. For reactivation, 5 g of Rongalit® C were added and stirring was carried out again for 30 min.

A finely divided polymer dispersion having a solids content of 28.8% and a mean particle size (Malvern) of 79 nm was obtained.

### EXAMPLE 5

101.4 g of glacial acetic acid were initially taken in a 2 l flask having a plane-ground joint and a stirrer and internal temperature measurement and were heated to 105° C. under a nitrogen atmosphere. A mixture of 110.50 g of styrene, 22.1 g of acrylonitrile, 48.6 g of N,N-dimethylaminopropylmethacrylamide, 4.4 g of acrylic acid and 4.4 g of n-butyl acrylate was metered in uniformly with stirring over a period of 45 min. The feed of 8.8 g of tert-butyl peroctanoate in 16.5 g of isopropanol was started simultaneously with the monomer feed and was metered into the reaction mixture in the course of 60 min. After the end of the initiator feed, stirring was continued for a further 30 min at a temperature of 105° C.

975 g of demineralized water were then added to the homogeneous mass of the prepolymer at 85° C. in the course of 30 min. After addition of 0.75 g of a 10% strength iron(II) sulfate solution, 20 g of a 5% strength hydrogen peroxide solution were metered in in the course of 30 min. Thereafter, a mixture of 210.0 g of acrylonitrile, 95.0 g of t-butyl acrylate and 20 g of ethylhexyl acrylate was metered in uniformly at 85° C. over a period of 120 min. Simultaneously with the monomer feed, a separate feed of 80.0 g of a 5% strength hydrogen peroxide solution was metered in over 150 min. After the end of the addition, stirring was continued for a further 60 min at 85° C. and the reaction mixture was then cooled to 50° C. For reactivation, 11.3 g of Rongalit® C were added and stirring was carried out again for 30 min at 50° C.

A finely divided polymer dispersion having a solids content of 30.2% and a mean particle size (Malvern) of 67 nm was obtained.

### EXAMPLE 6

101.4 g of glacial acetic acid were initially taken in a 2 l flask having a plane-ground joint and a stirrer and internal temperature measurement and were heated to 105° C. under a nitrogen atmosphere. A mixture of 110.50 g of styrene, 22.1 g of acrylonitrile, 48.6 g of N,N-dimethylaminoethyl acrylate, 4.4 g of acrylic acid was metered in uniformly with stirring over a period of 45 min. The feed of 8.8 g of tert-butyl peroctanoate in 16.5 g of isopropanol was started simultaneously with the monomer feed and was metered into the reaction mixture in the course of 60 min. After the end of the initiator feed, stirring was continued for a further 30 min at a temperature of 105° C.

975 g of demineralized water were then added to the homogeneous mass of the prepolymer at 85° C. in the course of 30 min. After addition of 0.75 g of a 10% strength iron(II) sulfate solution, 20 g of a 5% strength hydrogen peroxide solution were metered in in the course of 30 min. Thereafter, a mixture of 210.0 g of acrylonitrile, 95.0 g of t-butyl acrylate and 20 g of ethylhexyl acrylate was metered in uniformly at 85° C. over a period of 120 min. Simultaneously with the monomer feed, a separate feed of 80.0 g of a 5% strength hydrogen peroxide solution was metered in over 150 min. After the end of the addition, stirring was continued for a further 60 min at 85° C. and the reaction mixture was then cooled to 50° C. For reactivation, 11.3 g of Rongalit® C were added and stirring was carried out again for 30 min at 50° C.

A finely divided polymer dispersion having a solids content of 30.1% and a mean particle size (Malvern) of 72 nm was obtained.

### EXAMPLE 7

101.4 g of glacial acetic acid were initially taken in a 2 l flask having a plane-ground joint and a stirrer and internal temperature measurement and were heated to 105° C. under a nitrogen atmosphere. A mixture of 110.50 g of styrene, 22.1 g of acrylonitrile, 52.6 g of N,N-dimethylaminoethyl methacrylate, 4.4 g of acrylic acid was metered in uniformly with stirring over a period of 45 min. The feed of 8.8 g of tert-butyl peroctanoate in 16.5 g of isopropanol was started simultaneously with the monomer feed and was metered into the reaction mixture in the course of 60 min. After the end of the initiator feed, stirring was continued for a further 30 min at a temperature of 105° C.

975 g of demineralized water were then added to the homogeneous mass of the prepolymer at 85° C. in the course of 30 min. After addition of 0.75 g of a 10% strength iron(II) sulfate solution, 20 g of a 5% strength hydrogen peroxide solution were metered in in the course of 30 min. Thereafter, a mixture of 210.0 g of acrylonitrile, 95.0 g of t-butyl acrylate and 20 g of ethylhexyl acrylate was metered in uniformly at 85° C. over a period of 120 min. Simultaneously with the monomer feed, a separate feed of 80.0 g of a 5% strength hydrogen peroxide solution was metered in over 150 min. After the end of the addition, stirring was continued for a further 60 min at 85° C. and the reaction mixture was then cooled to 50° C. For reactivation, 11.3 g of Rongalit® C were added and stirring was carried out again for 30 min at 50° C.

A finely divided polymer dispersion having a solids content of 30.3% and a mean particle size (Malvern) of 65 nm was obtained.

### Comparative Example 1

60 g of glacial acetic acid, 60 g of styrene, 33 g of N,N-dimethylaminopropylmethacrylamide, 15 g of acrylic acid and 1 g of azobisisobutyronitrile were mixed under a nitrogen atmosphere in a 2 l flask having a plane-ground joint and a stirrer and internal temperature measurement and were heated to 85° C. with stirring and stirred at this temperature for a further 30 min. Thereafter, 1.25 g of azobisisobutyronitrile dissolved in 5 g of acetone were added at the same temperature over a period of 60 min. After the end of the addition, postpolymerization was effected for a further 30 min at 105° C.

590 g of demineralized water were then added at 85° C. to the resulting homogeneous solution of the prepolymer, with the result that a homogeneous, slightly turbid solution was obtained. After addition of 20 g of a 6% strength hydrogen peroxide solution and 1.2 g of a 10% strength iron(II) sulfate solution, 80 g of a 6% strength hydrogen peroxide solution and a mixture of 66 g of styrene and 126 g of isobutyl acrylate were metered in separately and uniformly with stirring at a temperature of 85° C. After the end of the feed, postpolymerization was effected at the same temperature for a further 60 min.

A finely divided polymer dispersion having a solids content of 28.4% and an LT value (0.1%) of 66% was obtained.

### Comparative Example 2

A mixture of 105.4 g of styrene, 40.0 g of N,N-dimethylaminopropylmethacrylamide, 0.8 g of tert-dodecyl mercaptan (95%) and 117.8 g of glacial acetic acid was initially taken at room temperature in a 2 l flask having a plane-ground joint and a stirrer and internal temperature measurement and was heated to 95° C. under a nitrogen atmosphere with stirring. After the reaction temperature had been reached, a solution of 2.0 g of azobisisobutyronitrile in 13.4 g of acetone was then metered uniformly into the reaction solution with stirring for a duration of 120 min. The batch was then stirred for a further 120 min at 95° C. and then cooled.

1260 g of demineralized water were added to the prepolymer at room temperature with stirring. The mixture was heated to 85° C. under a nitrogen atmosphere and with continued stirring. A homogeneous, slightly turbid liquid phase was obtained. After the reaction temperature had been reached, the mixture in the vessel was stirred for a further 15 min and then 20.0 g of 1% strength iron(II) sulfate solution were added. Thereafter a mixture of 129.5 g of styrene and 92.5 g of n-butyl acrylate, and 64.8 g of a 3% strength hydrogen peroxide solution, were metered into the reaction mixture simultaneously at constant metering rate from separate feeds, the temperature being kept constant. After the end of the feeds, the batch was stirred for a further 15 min at 85° C. and 2.3 g of tert-butyl hydroperoxide (70%) were then added for reactivation. After a further stirring time of 60 min at 85° C., the batch was cooled and an aqueous solution of Trilon® B was added at room temperature.

A finely divided polymer dispersion having a solids content of 19.7% and an LT value (0.1%) of 66% was obtained.

### Testing of Performance Characteristics 1

For testing the surface size effect during use, the dispersions according to the invention and the comparative dispersions were applied to a test paper (100% wastepaper, 80 g/m² basis weight, unsized) by means of a laboratory size press. An oxidized potato starch (Emox® TSC) was dissolved in water by heating to 95° C. and then adjusted to the desired concentration. The dispersions to be tested were then metered into the starch solution so that the size press liquor comprised 80 g/l of an oxidized, dissolved potato starch (Emox TSC) and 0.5-1.5 g/l of the dispersions.

The sizing effect of the dispersions from examples 1-7 and comparative examples 1 and 2 was then determined by surface application to the unsized test paper. For this purpose, the paper was passed twice through the size press, with the result that on average an increase in weight of about 65% was achieved. The drying of the surface-sized papers was effected on a drying cylinder at 90° C. The papers were then stored overnight in a conditioned chamber before the degree of sizing was determined.

### Cobb Value

The degree of sizing was determined according to Cobb, according to DIN EN 20 535. The water absorption is stated in g/m².

The results of the sizing test are shown in table 1.

TABLE 1

| | Cobb60 value [g/m2] | | | Cobb120 value [g/m2] |
|---|---|---|---|---|
| Dose of dispersion, | 0.5 | 1.0 | 1.5 | 1.0 |
| solid in g/l | | | | |
| Example 1 | 78 | 34 | 25 | 37 |
| Example 2 | 46 | 25 | 23 | 34 |
| Example 3 | 40 | 24 | 20 | 32 |
| Example 4 | 51 | 25 | 22 | 36 |
| Example 5 | 42 | 27 | 24 | 33 |
| Example 6 | 45 | 26 | 23 | 34 |
| Example 7 | 40 | 23 | 23 | 32 |
| Comparative Example 1 | 83 | 27 | 26 | 53 |
| Comparative Example 2 | 102 | 68 | 31 | 103 |

### Testing of Performance Characteristics (Immediate Sizing)2

For testing the immediate sizing effect during use, the dispersions according to the invention and the comparative dispersions were each applied to the surface of a test paper (mixture of pine sulfate, birch sulfate and eucalyptus, bleached, 80 g/m² basis weight, unsized, 18% ash) by means of a laboratory size press. An oxidized potato starch (Emox® TSC) was dissolved in water by heating to 95° C. and then adjusted to the desired concentration. The dispersions to be tested were then metered into the starch solution so that the size press liquor comprised 80 g/l of an oxidized, dissolved potato starch (Emox TSC) and 0.8-2.4 g/l of the dispersions.

The sizing effect of the dispersions from examples 1-7 and comparative examples 1 and 2 was then determined by surface application to the unsized test paper. For this purpose, the paper was passed once through the size press, with the result that on average an increase in weight of about 60% was achieved.

The drying of the surface-active sized papers was effected on a drying cylinder at 90° C. A part of the paper was then dried at 120° C. for 5 minutes, and the degree of sizing was determined (immediate determination, Cobb60 value). The other part of the papers was stored overnight in a conditioned chamber before the degree of sizing was determined.

### Cobb Value

The degree of sizing was determined according to Cobb60, according to DIN EN 20 535. The water absorption is stated in g/m².

The results of the sizing test are shown in table 2.

TABLE 2

| | | | | Cobb60 value |
|---|---|---|---|---|
| | | | | [g/m²] |
| | Cobb60 value [g/m²] | | | immediate |
| | (after 24 h ageing) | | | determination |
| Dose of dispersion, solid in g/l | 0.8 | 1.6 | 2.4 | 1.6 |
| Example 1 | 64 | 38 | 25 | 39 |
| Example 2 | 53 | 36 | 23 | 36 |
| Example 3 | 58 | 33 | 23 | 34 |
| Example 4 | 56 | 35 | 24 | 33 |
| Example 5 | 62 | 39 | 25 | 38 |
| Example 6 | 59 | 36 | 23 | 37 |
| Example 7 | 56 | 35 | 24 | 37 |
| Comparative Example 1 | 98 | 45 | 29 | 54 |
| Comparative Example 2 | 112 | 56 | 31 | 62 |

1. A finely divided, cationic polymer dispersion which is obtainable by emulsion polymerization of ethylenically unsaturated monomers in an aqueous solution of a cationic prepolymer as a dispersant, wherein the cationic prepolymer is first prepared by polymerization of
(a) from 10 to 45% by weight
of at least one (meth)acrylate which has at least one of an amino group and a quaternary ammonium group;
of at least one (meth)acrylamide which carries at least one of an amino group and a quaternary ammonium group; or
a combination thereof,
(b) from 40 to 85% by weight of at least one styrene,
(c) from 0 to 20% by weight of acrylonitrile or methacrylonitrile,
(d) from 1 to 15% by weight of at least one ethylenically unsaturated carboxylic acid or one ethylenically unsaturated carboxylic anhydride and
(e) from 0 to 20% by weight of at least one nonionic, ethylenically unsaturated monomer differing from the monomers (b) and (c),
the sum of (a)+(b)+(c)+(d)+(e) is 100% by weight, in a solution polymerization in a water-miscible organic solvent, and the solution of prepolymer thus prepared is diluted with water, and wherein an emulsion polymerization of a monomer mixture comprising
(i) from 30 to 80% by weight of acrylonitrile, methacrylonitrile or a combination thereof,
(ii) from 5 to 50% by weight of at least one C₁- to C₄-alkyl acrylate or at least one C₁- to C₄-alkyl methacrylate,
(iii) from 5 to 50% by weight of at least one C₆- to C₁₄-alkyl acrylate or at least one C₆- to C₁₄-alkyl methacrylate and
(iv) from 0 to 20% by weight of a nonionic monomer differing from the monomers (i), (ii) and (iii),
the sum (i)+(ii)+(iii)+(iv) is 100% by weight, is then carried out in the aqueous solution of the prepolymer in the presence of water-soluble polymerization initiators.

2. The finely divided, cationic polymer dispersion according to claim 1, wherein the cationic prepolymer is obtainable by polymerization of
(a) at least one of N,N-dimethylaminopropylmethacrylamide, N,N-dimethylaminoethyl methacrylate and N,N-dimethylaminoethyl acrylate,
(b) styrene
and
(d) at least one of acrylic acid and methacrylic acid.

3. The finely divided, cationic polymer dispersion according to claim 1, wherein the cationic prepolymer is obtainable by polymerization of
(a) at least one of N,N-dimethylaminopropylmethacrylamide, N,N-dimethylaminoethyl methacrylate, N,N-dimethylaminoethyl acrylate,
(b) styrene,
(c) acrylonitrile
and
(d) at least one acrylic acid and methacrylic acid.

4. The finely divided, cationic polymer dispersion according to claim 1, wherein the emulsion polymer is obtainable by polymerization of a monomer mixture comprising
(i) acrylonitrile,
(ii) at least one of n-butyl acrylate, isobutyl acrylate and tert-butyl acrylate
and
(iii) ethylhexyl acrylate.

5. (canceled)

6. The finely divided, cationic polymer dispersion according to claim 1, wherein the styrene is substituted.

7. The finely divided, cationic polymer dispersion according to claim 1, in the form of an engine size or a surface size for sizing paper, board, and cardboard.
